(19) United States
(12) Patent Application Publication
(10) Pub. No.: US 2006/0277768 A1
(43) Pub. Date: Dec. 14, 2006

(54) Electric tool for shaping of an object

(76) Inventors: Johannes Gerardus van Rijen, Prinsenbeek (NL); Matthew M. Rybka, Hoffman Estates, IL (US)

Correspondence Address: GREER, BURNS & CRAIN, 300 S WACKER DR, 25TH FLOOR, CHICAGO, IL, 60606, US

(21) Appl. No.: 11/413,700

(22) Filed: Apr. 28, 2006

(30) Foreign Application Priority Data
Apr. 29, 2005 (NL) 1028920

(51) Int. Cl. B23D 45/16

(52) U.S. Cl. 30/388

(57) ABSTRACT

Embodiments of the invention relates to an electric tool, in particular a circular saw, jigsaw or milling machine comprising a housing and a shaping tool that can be installed in a dismountable and rotatable way in the housing and wherein a laser unit is installed on or in the housing, which is outfitted to project a reference line that runs in the plane of an object to be shaped between the two sides of the installed shaping tool in its working direction and of which at least one side runs in or very close to the plane of one side of the shaping tool and wherein the laser unit can project a further reference line that runs in the plane of the object to be shaped between the two sides of the installed shaping tool in its working direction and of which at least one side runs in or very close to the plane of the other side of the shaping tool.

### BACKGROUND OF THE INVENTION

The invention generally relates to an electric tool, such as a circular saw, a jigsaw or a milling machine, comprising a housing and a shaping tool that can be placed in a dismountable and movable way in the housing, and a laser unit is installed on or in the housing, which is configured to project a reference line onto the surface of a relatively flat object or work piece to be shaped on one or both sides of the installed shaping tool in its working direction and of which at least one side runs in or very close to and preferably coextensive with the plane of a side of the shaping tool.

Such an electrical tool in the form of a manual circular saw is known from patent U.S. Pat. No. 5,461,790. In this, the laser unit projects a reference line by means of a rapidly back and forth movable, “fanning out” laser beam. The purpose of the projected reference line is to allow accurate positioning of the circular saw at the beginning of the saw cut. However, a saw cut has not only a direction but also a width. The known circular saw does not take account of this so that it cannot be guaranteed that the dimensions of the object to be sawn will be obtained correctly. There are known saws that attempt to solve this problem through shadow effects by the saw blade, but these are inaccurate or insufficiently obvious to the user.

### SUMMARY OF THE INVENTION

Embodiments of the present invention comprise an electric tool of the type which has a movable shaping tool for cutting at least a surface of a work piece, wherein the tool is configured to make a cut of a predetermined width when moved in a working direction during operation, and comprises a housing in which the movable shaping tool can be installed, a laser unit installed in the housing, the laser unit being configured to project onto the generally flat surface a first reference line that runs in the working direction, the first reference line having an outside edge on or very close to the plane of one side of the shaping tool, the laser unit also being configured to project onto the generally flat surface a second reference line that runs in the working direction, the second reference line having an outside edge on or very close to the plane of the other side of the shaping tool.

Other embodiments are directed to other aspects of the invention.

### DESCRIPTION OF THE DRAWINGS

FIG. 1 is a top view and a side view of a first embodiment of a circular saw with a laser unit and a work piece to be sawn;

FIG. 2 is a side view of a second embodiment of a circular saw with a laser unit;

FIG. 3 is a schematic representation of a third embodiment of a laser unit with a dual laser line;

FIG. 4 is a schematic representation of a fourth embodiment of a laser unit with a dual laser line;

FIG. 5 is a schematic representation of a variation of the fourth 11 embodiment of a laser unit with a dual laser line;

FIG. 6 is a schematic representation of a fifth embodiment of a laser unit with single laser line.

### DETAILED DESCRIPTION OF THE PREFERRED EMBODIMENTS

Broadly stated, an electric power tool such as a circular saw, jigsaw or milling machine is disclosed which has a housing to which a laser unit is provided, with the laser unit being configured to project a reference line onto the plane of the object to be shaped which would generally be a flat work piece or a work piece having a generally flat surface which would be cut. The laser unit projects at least one reference line on the two sides of the installed shaping tool in its working direction, and at least one outer edge of which runs on or very close to the outer reach of one side of the shaping tool. It is preferred that outer edges reference lines located on both sides of the shaping tool be on or very close to the outer reach of the shaping tool. In this manner, both sides of the cut to be made to the object can be indicated in a very clear and accurate manner and a user can see precisely where the material will be removed as a result of the cut. This reduces the chance of errors.

In this regard, by the sides of the installed shaping tool is meant more particularly, that two parallel planes are defined by the outermost sides or reaches of the cutting teeth of the saw blade or the cutting bit.

The laser unit can have its own power supply, for example, in the form of a battery, but it can also be fed by the main supply of the electric tool. The electrical power for the laser unit can also be generated by means of a dynamo driven by the rotation of the motor. Preferably, the laser unit can be switched on and off independently of the operation of the motor of the electric tool. The distance between the outer edges of the reference lines projected on the work piece on first and second sides is preferably adjustable to suit the dimensions of the installed shaping tool.

In a third preferred embodiment, the first side of the reference line is the side of a first reference line projected by a first laser beam and the second side of the reference line is the side of a second reference line projected by a second laser beam. Both reference lines do not necessarily have to project the same length. For instance, the second line can be set shorter because it indicates the width of the cut, whereas the first line also indicates the direction of the cut.

In a third preferred embodiment, the laser unit comprises two lasers, wherein the first laser unit is configured to project the first laser beam and the second laser unit is outfitted to project the second laser beam. In a fourth preferred embodiment, the laser unit comprises a laser and optical devices to split a source laser beam exiting from the laser unit into a first laser beam and a second leaser beam.

Preferably, the optical devices comprise two mirror planes of which one is semi-permeable. The mirror planes are preferably placed parallel to each other and at an oblique angle with the source laser beam. Furthermore, the mirror planes are preferably formed by two side planes of a transparent prism. Application of a transparent prismatic body has the advantage that the mutual position of the mirror planes is very stable. Additionally, the distance between the first reference line and the second reference line is preferably settable by adjusting the oblique angle between the mirror planes and the source laser beam. Also, the distance is also a function of the thickness of the prism, i.e., the distance between the mirror planes. In a variation of the fourth preferred embodiment, a third mirror plane is placed in the path between the laser and the semi-permeable mirror. This third mirror reverses the source laser beam, so that the first two mirror planes can be placed alongside the laser. This allows a more compact construction of the laser unit. The mutual positions of the mirror and the mirror planes with semi-permeable mirror can also be reversed.

In a fifth preferred embodiment, the first side of the reference line and the second side of the reference line are two different sides of the same reference line extending over the width of the shaping tool. Preferably, the width of the reference line can be set by means of a lens.

Preferably, the first laser beam and the second laser beam each have a different color. For instance, the projected reference line at the side of the waste portion can have a red color and the reference line at the side of the part to be manufactured can have a green color.

Preferably, the angle of the laser unit with the plane of the object to be shaped is adjustable. This also applies to the angle of the laser unit with the plane of the saw blade. Furthermore, the laser unit is preferably adjustable sideways with reference to the saw blade. By this, the position with respect to the saw blade of the reference lines can be set precisely. The start point of the projected lines lies as close as possible to and is preferably coextensive with the point where the electric shaping tool is performing its work, such as the saw cut.

Preferably, an optical lens is placed in the path of the laser beams. By doing so, the quality of the projected reference lines can be manipulated and controlled, such as adjustment of the start point and line length, clarity, width, mutual distance and parallelism.

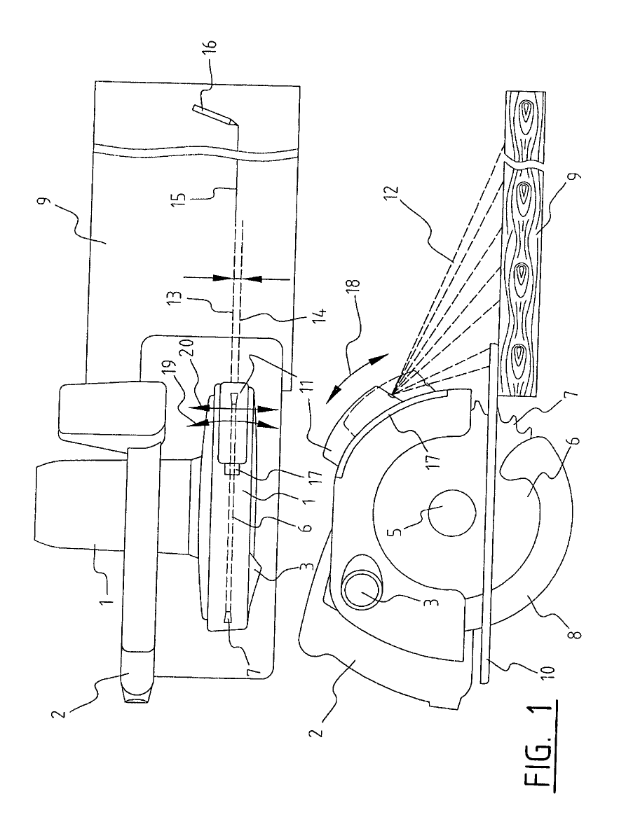

Turning now to the drawings, and particularly FIG. 1, a circular saw is illustrated which has a housing 1 with a first handle 2 and a connection 3 for a chips collecting bag or a dust extractor, and a drive motor located in the housing 1. A circular shaped saw blade 6 is attached to the drive shaft 5. As is common, the saw blade 6 has teeth 7 at its outer periphery. The bottom side of the rear part of the contour of the saw blade 6 is surrounded by a protection guard 8 that can rotate around the drive shaft 5 and that can be pushed away by the work piece or object 9 to be cut so that the protection guard 8 is retracted in the housing 1. At the bottom side of the housing 1, a support surface 10 with a relatively flat bottom surface is provided, which can glide over the object 9. The support surface 10 is provided with a slot through which the saw blade 6 as well as the protection guard 8 can extend.

The circular saw is provided with a laser unit 11 that, through the use of optical devices, can project two fanning out laser beams 12 and thus project two parallel reference lines 13, 14 on the object to be cut. The reference lines 13, 14 can also be formed by the sides of the projection line of a single wide laser beam 12 or by the sides of the projection lines of two separate laser beams 12. At the beginning of the sawing operation, the circular saw is directed in such way that one of the reference lines 13, 14 preferably coincides with a line 15 that was previously put on the object, for instance with a pencil 16.

The distance between the outside edges of the reference lines 13, 14 is preferably adjustable to coincide with the saw cut width to be obtained, so that the user can clearly see what will be cut away and what will become the associated waste. Stated in other words, the distance between the outside edges of the reference lines indicates the saw cut width, i.e., the distance between the outer sides of the saw teeth. In line with the saw blade to be used, the distance between the outside edges of the reference lines can be set at the saw cut width. In fact, such setting can be performed at the factory or by the user.

The housing of the laser unit 11 or the laser unit 11 as such is attached in accordance with arrow 18 in a movable way in a groove 17 located in the circularly shaped part of the upper part of the front side of the housing 1. The laser unit 11 can also be rotated around the radial axis according to arrow 19, and can be slid in a sideways direction according to arrow 20 to allow accurate setting of the laser beams 12. The laser beams are set at both sides of the saw blade according to the direction of the saw blade and the position of the saw teeth.

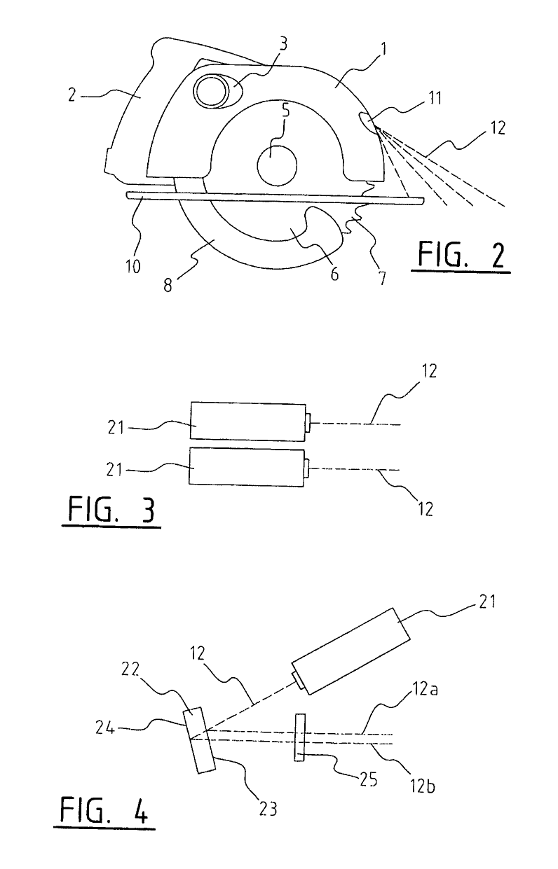

In a second embodiment according to FIG. 2, the laser unit 11 is enclosed in the housing 1. Hence, only the output window of the laser unit can be seen in FIG. 2. Preferably, the laser in the built-in laser unit is nonetheless adjustable in the directions indicated in FIG. 1.

In a third embodiment according to FIG. 3, the laser unit 11 comprises two separate lasers 21 each of which produce a separate laser beam 12 that is parallel to the other.

In a fourth embodiment according to FIG. 4, the laser unit 11 comprises a laser 21 that produces a single source laser beam 12 that is split into two laser beams 12a, 12b by means of a prism 22 with a first semi-permeable mirror plane 23 and a second totally reflecting mirror plane 24. The laser beams 12a, 12b are spread to the desired width by a lens 25. The distance between the laser beams 12a, 12b can be set by rotating the prism 22, possibly together with the laser 21. The prism 22, possibly together with the laser 21, is rotated in such way that the direction of the laser beams 12a, 12b does not change.

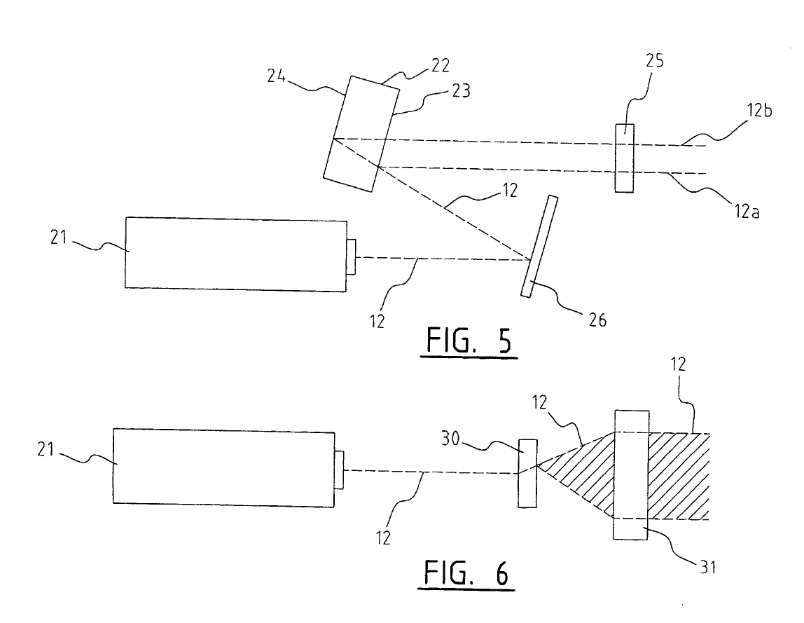

In a variation of the fourth embodiment according to FIG. 5, the laser unit 11 comprises a laser 21 that produces a single source laser beam 12 that is reflected by means of a first mirror plane in the form of a mirror 26. This reflected laser beam 12 is then reflected again by a parallel prism 22 with a first semi-permeable mirror plane 23 and a second totally reflecting mirror plane 24, by which a parallel beam bundle 12a, 12b exits from the laser unit. The outer sides of the laser beams 12a, 12b project in this manner the reference lines 13, 14. The distance between the laser beams 12a, 12b can be set by rotating the mirror 26 together with the prism 22, so that their mirror planes remain parallel. To obtain an even compacter laser unit, the laser 21 can also be installed at an angle and not parallel with the exiting laser lines 12a, 12b.

In the fifth embodiment shown in FIG. 6, the source laser beam 12 created by the laser 21 is changed into a wide laser beam 12 by means of a first lens 30 and a second lens 31. The thickness of this laser beam 12 indicates the width of the saw cut.

The invention is not limited to the embodiments shown in the drawings. For instance, in the embodiment in FIG. 5, it is possible to switch the prism 22 and the mirror 26. Besides this, a laser unit according to the invention can just as well be applied with, for instance, a jigsaw, a milling machine or any other kind of shaping or cutting tool.

While various embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the following claims.

What is claimed is:

1. An electric tool of the type which has a movable shaping tool for cutting at least a surface of a work piece, wherein the tool is configured to make a cut of a predetermined width when moved in a working direction during operation, comprising;
a housing in which the movable shaping tool can be installed;
a laser unit installed in the housing, said laser unit being configured to project onto the surface a first reference line that runs in the working direction, said first reference line having an outside edge on or very close to the plane of one side of the shaping tool, said laser unit being configured to project onto the surface a second reference line that runs in the working direction, said second reference line having an outside edge on or very close to the plane of the other side of the shaping tool;
wherein said first and second reference lines are substantially parallel to one another and said outside edges thereof are spaced from one another a distance that is generally equal to the predetermined width.

2. The electric tool according to claim 1 wherein the distance between said outside edges of said first side and second sides is adjustable.

3. The electric tool according to claim 1 wherein said first and second reference lines are projected by a single laser beam.

4. The electric tool according to claim 1 wherein said first reference line is projected by a first laser beam and said second reference line is projected by a second laser beam.

5. The electric tool according to claim 4 wherein the laser unit comprises two lasers, in which the first laser is configured to project the first laser beam and the second laser is configured to project the second laser beam.

6. The electric tool according to claim 1 wherein the laser unit comprises a laser and optical devices to split a source laser beam exiting from said laser into a first laser beam and a second laser beam.

7. The electric tool according to claim 6 wherein said optical devices comprise first and second mirror planes of which at least one is semi-permeable.

8. The electric tool according to claim 7 wherein said mirror planes are parallel to one another and are placed at an oblique angle with said source laser beam.

9. The electric tool according to claim 7 wherein the mirror planes are formed by two side planes of a transparent prism.

10. The electric tool according to claim 8 wherein the distance between said outer edges of first and said second reference lines can be set to coincide with the size of the shaping tool.

11. The electric tool according to claim 7 wherein a third mirror plane is placed in the path between said laser and said semi-permeable mirror.

12. The electric tool according to claim 4 wherein the first laser beam and the second laser beam each have a different color.

13. The electric tool according to claim 1 wherein the angle of the laser unit relative to said flat surface of the work piece is adjustable.

14. The electric tool according to claim 1 wherein the angle of the laser unit relative to the angular orientation of the shaping tool is adjustable.

15. The electric tool according to claim 1 wherein the laser unit is laterally adjustable relative to the shaping tool.

16. The electric tool according to claim 1 wherein an optical lens is placed in the path of the laser beams.

17. The electric tool according to claim 1 wherein the tool is a circular saw and the shaping tool is a flat circular saw blade.

18. A portable power circular saw of the type which has a rotatable flat circular saw blade for cutting a work piece, wherein the blade is configured to make a cut of a predetermined width when moved in a working direction during operation, said saw comprising:
a housing in which the blade can be installed;
a laser unit mounted to said housing, said laser unit being configured to project at least one laser beam onto the work piece to define first and second reference line outer edges that extend in the working direction, said outer edges being generally coextensive with the outer reaches of opposite sides of the blade to define a projected cut line having edges that substantially coincide with the width of the blade.

19. A circular saw as defined in claim 18 wherein said laser unit is configured to adjust the distance between said outer edges.

20. The electric tool according to claim 10 wherein the distance between said outer edges of first and said second reference lines can be set by adjusting the oblique angle between said mirror planes and said source laser beam.

21. The electric tool according to claim 10 wherein the distance between said outer edges of first and said second reference lines can be set by setting the distance between said parallel mirror planes.
